(19) United States
(12) Patent Application Publication
(10) Pub. No.: US 2009/0219170 A1
(43) Pub. Date: Sep. 3, 2009

(54) Wireless network inventory system

(76) Inventors: Ryan C. Clark, Pflugerville, TX (US); James G. Kyker, Round Rock, TX (US); Jonathan P. Kyker, Round Rock, TX (US); James C. Kyker, Pflugerville, TX (US)

Correspondence Address: MCDERMOTT, WILL & EMERY LLP;Attn: IP Department, 227 WEST MONROE STREET, SUITE 4400, CHICAGO, IL, 60606-5096, US

(21) Appl. No.: 12/378,652

(22) Filed: Feb. 18, 2009

Related U.S. Application Data
(60) Provisional application No. 61/029,446, filed on Feb. 18, 2008.

(51) Int. Cl. G08B 5/22

(52) U.S. Cl. 340/825.49

(57) ABSTRACT

A wireless location system is provided. The system includes network tags that emit a signal containing tag data, network readers that continuously receive data from the tags, a communication motes to receive the tag data from the readers and to calculate a network signal strength of the signal between the reader and the mote, and a server. The server receives the tag data and network signal strength data from the communication mote, performs calculations on the data, and determines the location of the reader that received the tag data based in part on the received network signal strength data.

### CROSS-REFERENCE TO RELATED APPLICATIONS

This application is a continuation-in-part of U.S. Provisional Patent Application Ser. No. 61/029,446, filed on Feb. 18, 2008, which is expressly incorporated herein by reference.

### FEDERALLY SPONSORED RESEARCH OR DEVELOPMENT

Not Applicable.

### TECHNICAL FIELD

The present invention relates generally to a system and method for transferring data in a network, and more specifically to a method for transferring sensor data in a wireless network for inventory purposes. Device commands may also be transferred through said network.

### BACKGROUND OF THE INVENTION

Inventory management and tracking systems are well known in the art. One type of inventory management and tracking system involves the use of sensors and global positioning systems (GPS) to allow the system to determine the location of items to be tracked. Another type of inventory management and tracking system involves the use of triangulation which may be based on fixed location readers. While such systems according to the prior art provide a number of advantageous features, they nevertheless have certain limitations. For example, GPS systems often cannot be used in many indoor applications, and many triangulation systems require increased hardware which can be expensive. Additionally, in prior art systems location tracking and inventory management are conducted separately on separate systems. The present invention seeks to overcome certain of these limitations and other drawbacks of the prior art, and to provide new features not heretofore available. A full discussion of the features and advantages of the present invention is deferred to the following detailed description, which proceeds with reference to the accompanying drawings.

### SUMMARY OF THE INVENTION

The present invention generally provides an inventory management and tracking system. According to one embodiment a wireless locating network is disclosed. The network comprises a tag containing data, a reader to receive the data from the tag, at least one network mote to receive the data from the reader, and a host computer to receive the data from the mote. The host computer analyzes the data and tracks the location of the tag within the network. In one embodiment the tag is connected to an object to be tracked.

According to another embodiment, at least one of the readers in the network is movable within the network.

According to another embodiment, at least two types of network motes are provided in the network. A first network mote operates as a router and only communicates with readers and other network motes, and a second network mote communicates with the host computer. Additionally, in an alternate embodiment at least one of the motes has a reader. In one embodiment the mote does not store location data.

According to another embodiment, the host computer processes tag data, determines an actual location of the reader receiving the tag data based on network signal strength data, and stores the tag data in a database. In a preferred embodiment all location determinations are performed by the host computer. Additionally, in various embodiments the location calculations performed by the host computer are based on a predictive algorithm. In one predictive algorithm historical network signal strength values are used in connection with the most current network signal strength.

According to another embodiment, the network is a wireless mesh network. The reader has a wireless mesh receiver/transmitter, and the network mote has a wireless mesh network data modulator, a CPU, and memory. The mote determines the network signal strength. The host computer receives communications from the wireless mesh network mote to track the location of the tag.

According to another embodiment, the host computer resides on a network separate from the wireless mesh network.

According to another embodiment, the tag is an RFID tag that contains RFID tag data.

According to another embodiment, a plurality of network tags are used. Each tag has independent tag data and each tag emits a signal containing the tag data. The network also has a plurality of network readers to continuously receive data from tags within a certain range of the reader. The readers transmit the received tag data to communication motes. The communication motes receive the tag data from the readers, and calculate the network signal strength of the signal between the reader and the mote. A server is provided in the system to receive the tag data and network signal strength data from the communication mote, and also to perform calculations on the data and determine the location of the reader that received the tag data based in part on the received network signal strength data.

According to another embodiment, a wireless location system is provided having a plurality of wireless mesh node beacons, a wireless mesh communication mote, and a host computer. The wireless mesh node beacons are adapted to be fixed to movable objects. The wireless mesh communication mote has a receiver/transmitter, data modulator, processor and associated memory. The mote receives a signal from the beacon. The host computer identifies an object following communication from the communication mote, and the host computer also tracks the location of each beacon.

According to another embodiment, the host computer has a database that stores data associated with the objects, and an integral location and data processing sub-system that analyzes information stored in the database and executes algorithms to determine the current location, in real time, of the network beacon.

According to another embodiment, a wireless location system is provided having a plurality of node beacons adapted to be fixed to movable objects, a communication mote having a receiver/transmitter, and a host server resident on a secondary network. The node beacons send signals containing data related to the object to which they are affixed. The mote receives the signal from the beacon and buffers the data in its internal memory. The mote also performs a network signal calculation. The host server receives data from the communication mote related to the network signal calculation and the signal the mote received from the beacon, identifies the object having the node beacon, processes the data and tracks the location of each beacon. The host server also stores the data in a database resident in the host server.

According to another embodiment, a wireless locating network is provided. The network comprises a sensor, at least one network mote, and a host computer. The sensor obtains atmospheric data and transmits the atmospheric data to the network mote, which subsequently transfers the data to the host computer for processing.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a block diagram of an embodiment of a system for communicating tag data in a wireless network. Device commands may also be transferred through said network.

FIG. 2 is a flow diagram of another embodiment of a method of communicating tag data in a wireless network. Device commands may also be transferred through said network.

FIG. 3 is a flow diagram of another embodiment of a method of communicating tag data in a wireless network, wherein the reader antennas physically maneuver to scan an area. Device commands may also be transferred through said network.

FIG. 4 is a flow diagram of another embodiment of a method of communicating tag data in a wireless network, wherein the reader antennas and the readers physically maneuver to scan an area. Device commands may also be transferred through said network.

FIG. 5 is a flow diagram of an embodiment of a method of using a wireless network to track the physical location of a tag.

FIG. 6 is a flow diagram of another embodiment of a method of associating unique tags with inventory for use in a wireless network for tracking the physical location of a tag.

FIG. 7 is a flow diagram of another embodiment of a method of tracking the physical location of a tag.

FIG. 8 is a flow diagram of an embodiment of a method of using various networks and systems for location management and data management when tracking the physical location of items.

FIG. 9 is a flow diagram of another embodiment of a method of using various networks and systems for location management and data management when tracking the physical location of items.

FIG. 10 is a block diagram of another embodiment of a method of communicating sensor data in a wireless network. Device commands may also be transmitted.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

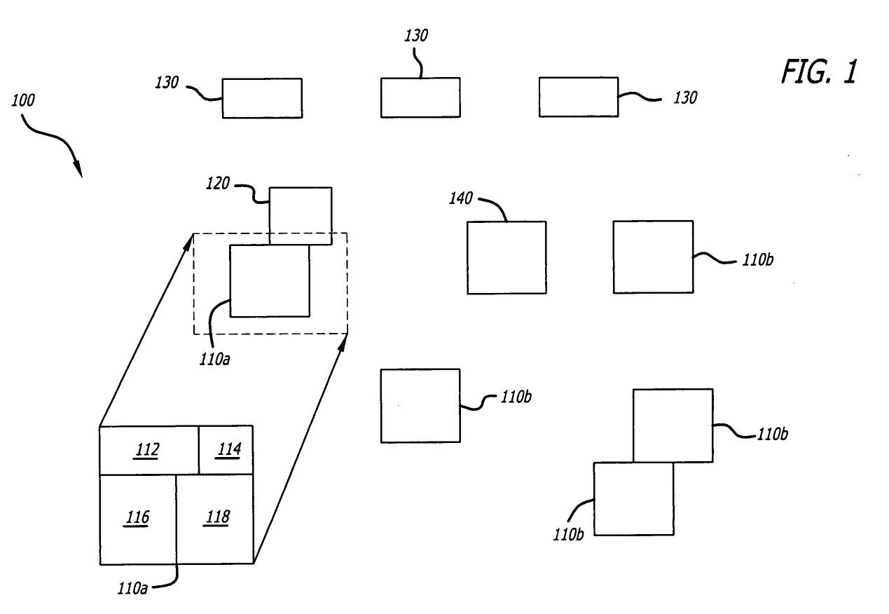

Referring now to the Figures, FIG. 1 illustrates an embodiment of a data management and location tracking system for communicating data in a network 100. Device commands may also be transferred through said network 100. As shown in the example in FIG. 1, the network 100 may be a network in which there are at least two pathways of communication to each node, such as a wireless mesh network. However, it is contemplated that any type of network may be used to accomplish the objective of the present invention, including other forms of wired and wireless networks.

In one embodiment a tag is connected to the object to be tracked or located. The tag contains data regarding the object, and the data is preferably transmitted from the tag on the object. In such an embodiment, a reader is also employed to read or receive the data that is transmitted from the tag. In one such embodiment the tag data is in the form of radio-frequency identification (RFID) tag data, and the reader is an RFID reader. In the preferred embodiment, device commands are not transmitted/received in the network, however, in alternate embodiments, device commands may be transmitted/received in the network as RFID device commands.

Radio-frequency identification is an automatic identification method that relies on storing and remotely retrieving data using devices called RFID tags or transponders. An RFID tag is an object that can be applied to or incorporated into a product or object for the purpose of identification using radio waves, however, alternate types of RFID tags may be employed. Some RFID tags can be read from several meters away and beyond the line of sight of the RFID reader. Most RFID tags contain at least two parts. One is an integrated circuit for storing and processing information, modulating and demodulating a radio-frequency (RF) signal, and other specialized functions. The second is an antenna for receiving and transmitting the signal. Another technology, called chipless RFID, allows for discrete identification of tags without an integrated circuit, thereby allowing tags to be printed directly onto objects at a lower cost than traditional tags.

One of ordinary skill in the art would readily understand, however, that alternate tagging technologies and associated reading technologies may be utilized in place of or in connection with RFID technology without departing from the scope and spirit of the present invention. For example, one alternate technology is RuBee. RuBee (IEEE P1902.1) is a two way, active wireless protocol that uses Long Wave (LW) magnetic signals to send and receive short (128 byte) data packets in a local regional network. The RuBee protocol is similar to the IEEE 802 protocols such as WiFi (IEEE 802.11), WPAN (IEEE 802.15.4) and Bluetooth (IEEE 802.15.1), in that RuBee is networked by using on-demand, peer-to-peer, active radiating transceivers. However, RuBee generally uses a low frequency (131 kHz) carrier. This low operating frequency provides RuBee with the advantages of ultra low power consumption (battery life measured in years), and normal operation near steel and/or water. For exemplar purposes only, the following embodiments will be described as utilizing RFID technology.

As shown in FIG. 1, in one embodiment the network 100 includes a plurality of motes or nodes 110, an RFID reader 120, RFID tags 130 and a host computer or server 140. The host computer or server 140 includes, inter alia, a controller and software, which may or may not control the communication within and other functions of the network 100. Each mote 110 preferably houses memory 112 associated with a CPU 114, a wireless mesh network data modulator 116 and a wireless mesh network receiver/transmitter 118. The wireless mesh network data modulator 116 (“WMNDM 116”) utilizes an algorithm to compile data, such as tag data, into a packet format for transfer through the wireless network 100. In a preferred embodiment, however, the mote 110 does not receive data from the server 140. Additionally, other than compiling data for ultimate transmission to the server 140 and determining network signal strength, the motes 110 do not perform other calculations or computations. Rather, all computations to determine location are performed at the server 140—the motes 110 do not calculate or know location information. Thus, in a preferred embodiment all location calculation and tag processing is performed in a single location, at the server 140. Such a server 140 processes tag information, determines actual location (preferably of the reader) which allows for a general determination of the object to be tracked, and stores the data in a database. Additionally, in a preferred embodiment the motes 110 do not store location data. All data is stored at the server 140 in the preferred embodiment. Accordingly, the endpoint and coordinator motes 110 are much less expensive in the present invention because extraneous memory is not required for the motes 110.

In the example shown in FIG. 1, there are two types of motes 110: endpoint motes 110a and coordinator motes 110b. Endpoint motes 110a are preferably associated with a reader 120, for example through an electrical connection, whereas coordinator motes 110b generally may not be associated with a reader 120. Accordingly, endpoint motes 110a are used to collect and relay data through the network 100, whereas coordinator motes 110b simply relay data between motes 110 (such as a router) or to the server host computer 140. Additionally, as explained herein, the motes 110 determine network signal strength.

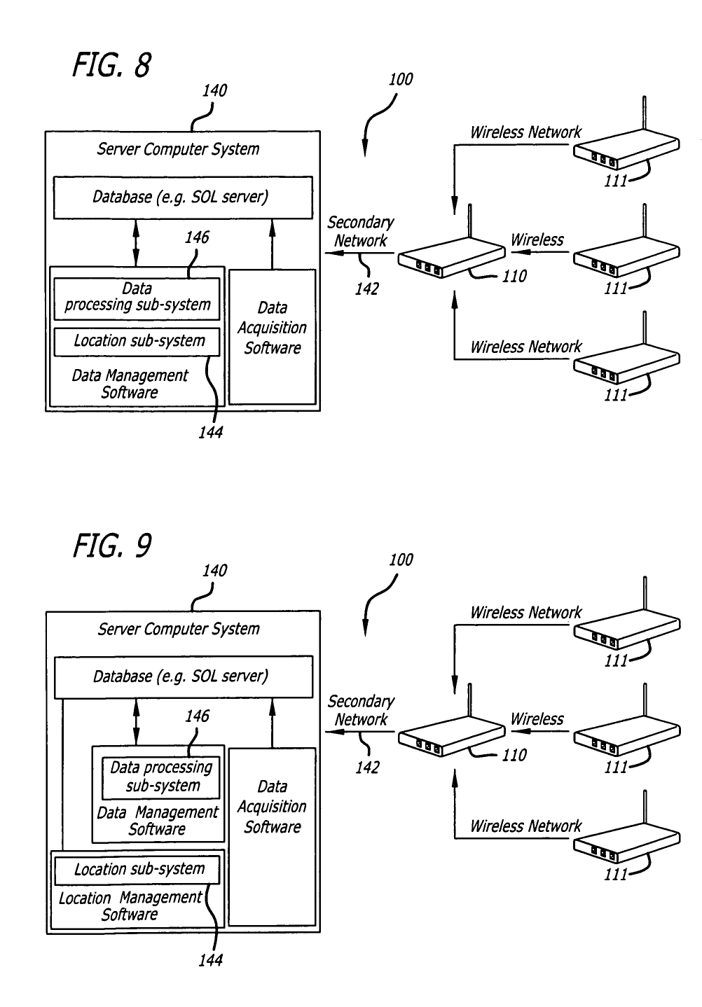

In one embodiment the server 140 resides on first network 100. In an alternate embodiment the server 140 resides on a second network 100a. In such an alternate embodiment not all of the coordinator motes 110b may be connected to the second network 100a. Accordingly, some of the coordinator motes 110b may operate merely as routers within the network 100 to receive and transmit data (and also to calculate network signal strength from routed network signals/data), whereas other coordinator motes 110b are connected to the second network 100a to transmit data to the server 140 resident on the second network 100a (see FIGS. 8 and 9).

As described above, endpoint motes 110a collect data to be relayed through the network 100. In the example shown in FIG. 1, the endpoint motes 110a may obtain RFID tag data from their associated RFID readers 120, which is then stored in the mote's memory 112. The CPU 114 then causes the RFID tag data to be transferred to the WMNDM 116, such that the RFID tag data is assembled into a packet structure conforming to the specifications of the transfer protocol for the network 100. For example, a suitable transfer protocol is IEEE 802.15 for Wireless Personal Area Networks (“WPANs”); however, other protocols may be used, such as, for example, IEEE 802.11. The wireless mesh network receiver/transmitter 118 then broadcasts the data packet such that the data packet is transmitted to the host computer 140 via one or more motes 110. In alternate embodiments, described supra herein, one or more motes 110 may be employed as an active tag.

In contemplated embodiments of the present subject matter, the network 100 may be used in an inventory tracking system. For example, individual RFID tags 130 may be placed on pallets, groups of products or objects, each individual product or object, etc. In the example where individual RFID tags 130 are placed on individual products/objects, the RFID tag 130 may include data regarding said object, such as, but not limited to, a product number, an MSRP, an SKU, the manufacturer's identification, the product's name, and/or the product type. In a preferred embodiment, the RFID tag 130 data only includes the unique tag identifier, however, alternate embodiments may include, but are not limited to, data regarding said object as previously mentioned. Accordingly, the RFID tags 130 and RFID readers 120 communicate such that the RFID readers 120 gather information regarding the products in their proximity. For example, an RFID reader 120 may be associated with each storage unit, such as, for example shelving units or storage bins, such that the RFID reader 120 gathers information about the products stored in the corresponding storage unit and communicates that information to the host computer 140 via the motes 110. Alternatively, or in addition, each RFID reader 120 may gather information regarding any product having an RFID tag 130 within a given distance, such as, for example, two meters. The gathered information may then be communicated back to the host computer or server 140 via the motes 110. The host computer 140 may then use the collected information to perform location, tracking or other product analysis. Because the network 100 and its components may operate continuously, the network 100 is preferably used to track and analyze the tagged products in real time.

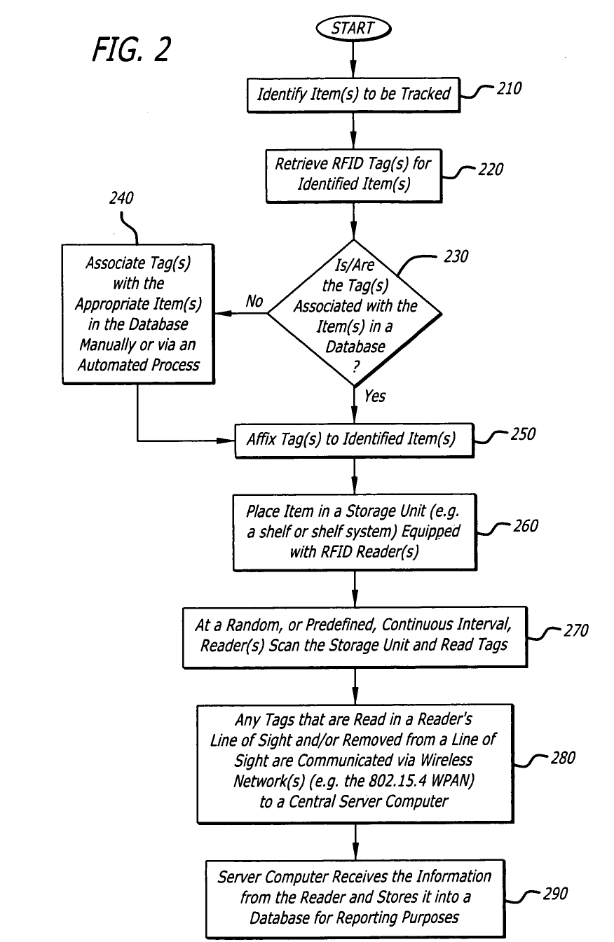

FIGS. 2-4 illustrate exemplar process flows for tracking items, such as inventory, via a network 100, such as the wireless mesh network described above with reference to FIG. 1. Components of the systems described in FIGS. 2-4 will be identified with the reference numerals used above with respect to FIG. 1.

First, in steps 210, 310 and 410, the items to be tracked are identified by either a manual or automated process. For example, items inbound to a warehouse from the loading dock may automatically be identified to be tracked. Alternatively, they may be identified manually as they enter the warehouse. After each item to be tracked is identified, a unique RFID tag 130 to be associated with each item is retrieved in steps 220, 320 and 420. The host computer 140 is then used to determine whether each of the unique RFID tags 130 is associated in the system database with the item for which it will be used to track in steps 230, 330 and 430. If an item and corresponding RFID tag 130 have not yet been associated, steps 240, 340 and 440 are employed to make the association, either manually or via an automated process. In one contemplated example, the host computer 140 stores the RFID tag data and the associated item information in a database. The database may be integral with the host computer 140 or may be associated with the host computer via a network or other physical or wireless connection. Entries to the database may then be manually or automatically updated to ensure each RFID tag 130 and its corresponding item are properly associated. As described above with respect to FIG. 1, the RFID tag 130 may include identification information relating to the items, such as, but not limited to, a product number, an MSRP, an SKU, the manufacturer's identification, the product's name, and/or the product type. In a preferred embodiment, the RFID tag 130 data only includes the unique tag identifier, however, alternate embodiments may include, but are not limited to, identification information relating to the items as previously mentioned. After all of the RFID tags 130 and corresponding items have been properly associated, the appropriate RFID tag 130 is affixed to each item, for example, by physically affixing the RFID tag 130 to the item, in steps 250, 350 and 450.

After each of the items and corresponding RFID tags 130 have been associated and physically connected, the next step is to place each of the items in a storage location equipped with or otherwise in range of an RFID reader 120, as shown in steps 260, 360 and 460. In the example of tracking inventory in a storage warehouse, the storage location may be, for example, a storage unit such as a shelf or a bin. Alternatively, the storage location may be a pallet, a stack or, most broadly, any physical location. Accordingly, the RFID reader 120 may be connected to, or in close proximity to, the storage location. For example, the RFID reader 120 may be attached to a storage shelf or may be maneuverable along a track attached to one or more storage shelves.

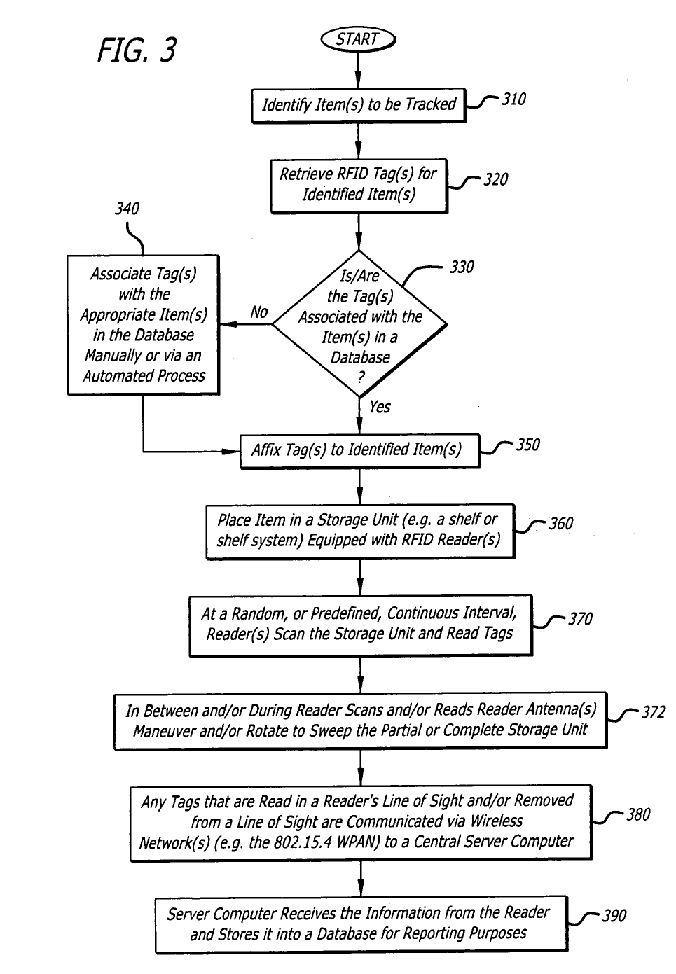

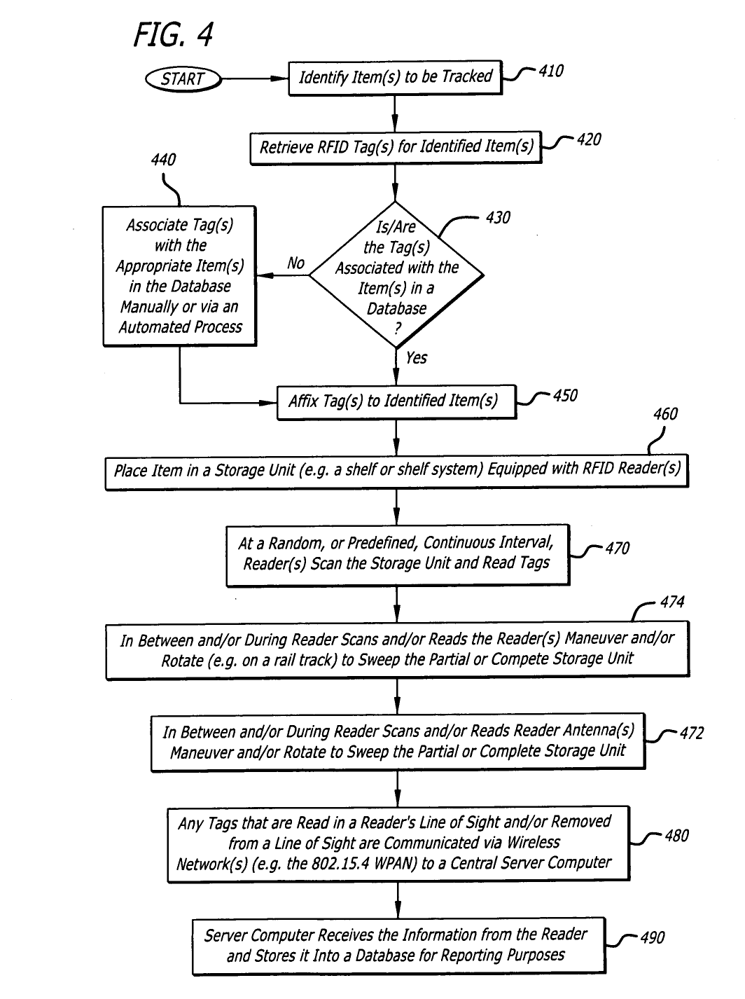

In steps 270, 370 and 470, the RFID readers 120 scan the storage locations and acquire the RFID information from the RFID tags 130. The scanning process may occur at random or predefined intervals, as dictated by the motes 110 and/or the host computer 140. In order to increase the effective coverage area of each RFID reader 120, the RFID readers 120 may also conduct additional scanning processes. For example, as shown in FIGS. 3 and 4 in steps 372 and 472, respectively, in between and/or during the scanning process in steps 370 and 470, the reader antenna(s) of each RFID reader 120 may rotate and/or otherwise maneuver to scan a larger storage area. For example, directional antennas may be designed to rotate partially or fully to increase their coverage. Similarly, as shown in FIG. 4 in step 474, in between and/or during the scanning processes in steps 470 and 472, the RFID readers 120 themselves may rotate and/or otherwise maneuver to scan a larger storage area. For example, a mobile RFID reader 120 may be associated with a shelving unit such that the RFID reader 120 traverses a track and scans a larger storage area or greater number of shelves than a stationary RFID reader 120 would be capable of scanning. The additional scanning steps shown in steps 372, 472 and 474 increase the effective coverage area of each RFID reader 120, thereby increasing the efficiency of the network 100.

Any information scanned and compiled from the RFID tags by the RFID readers 120 in any of the prior steps is then communicated via the motes 110 to the host computer 140, as shown in steps 280, 380 and 480. The information may include, for example, only static information, such as the present location of each RFID tag 130 or it may include dynamic information, such as whether the location of each RFID tag 130 has changed since the previous scan cycle. Accordingly, the information read and conveyed will vary by application and requirements of the end user. As described above with reference to FIG. 1, the information collected by the RFID readers 120 may be communicated to the host computer 140 via a wireless mesh network using, for example, a low power wireless communication protocol such as the 802.15.4 standard.

Finally, as shown in FIGS. 2-4, in steps 290, 390 and 490 the host computer 140 receives the information from the RFID readers 120 and stores the information in a database for tracking, reporting, or other purposes as dictated by the application and the software utilized by the host computer 140.

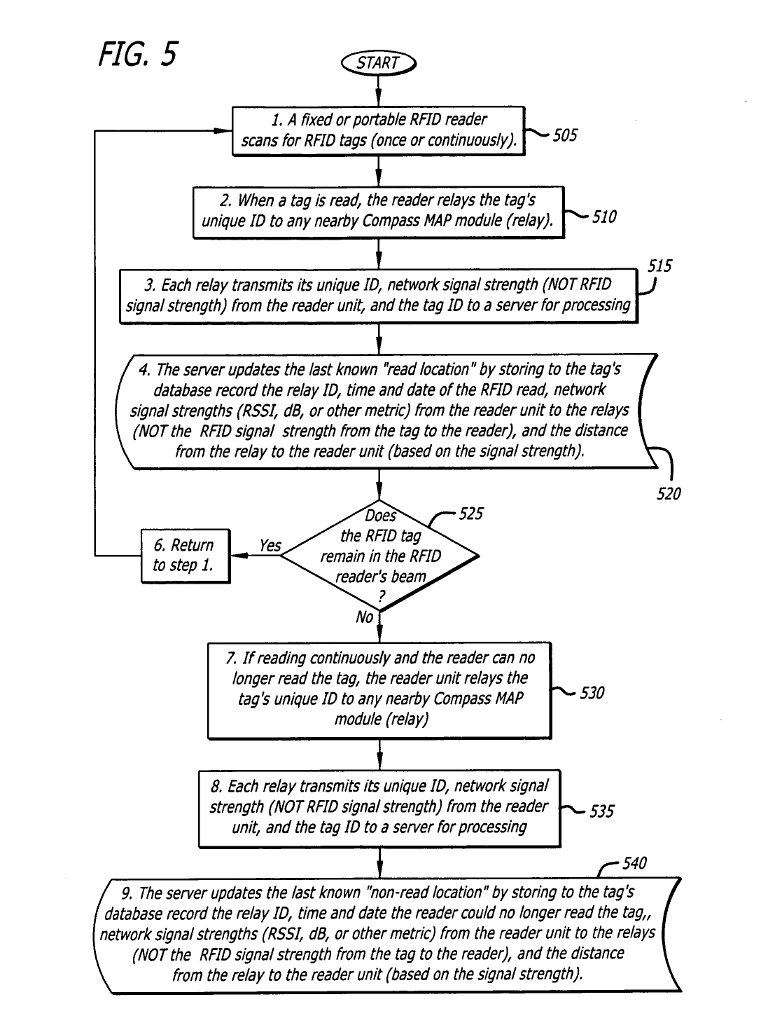

FIGS. 5-7 illustrate additional embodiments for exemplar process flows for tracking items, such as inventory, via a network 100, such as the wireless mesh network described above with reference to FIG. 1. Components of the systems described in FIGS. 2-4 will be identified with the reference numerals used above with respect to FIG. 1.

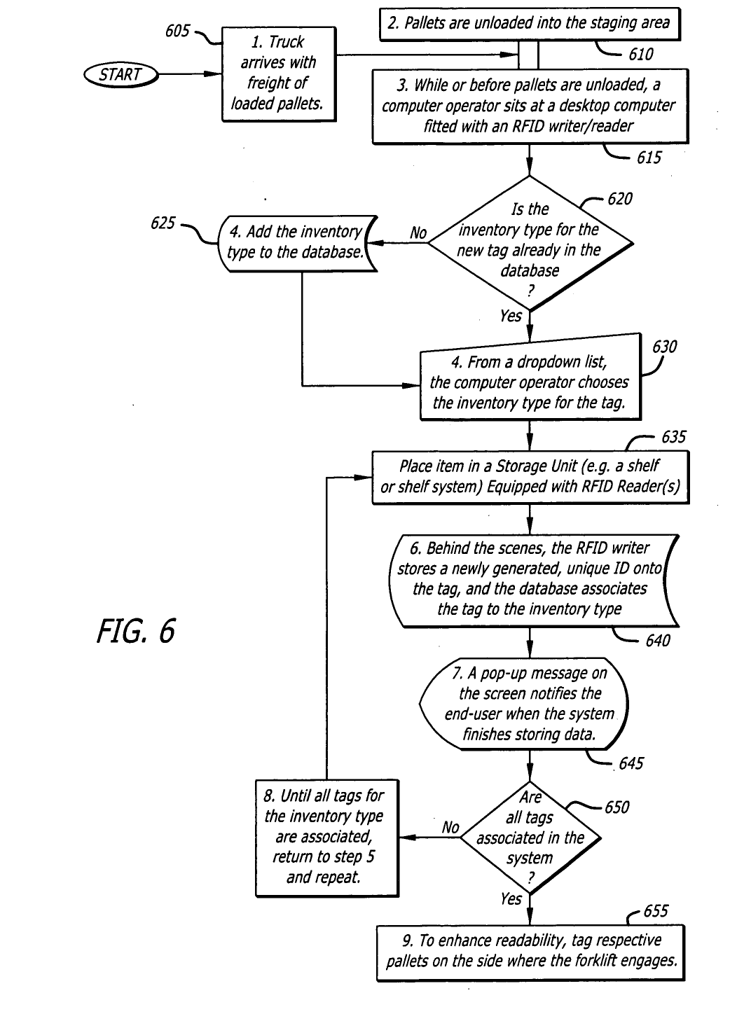

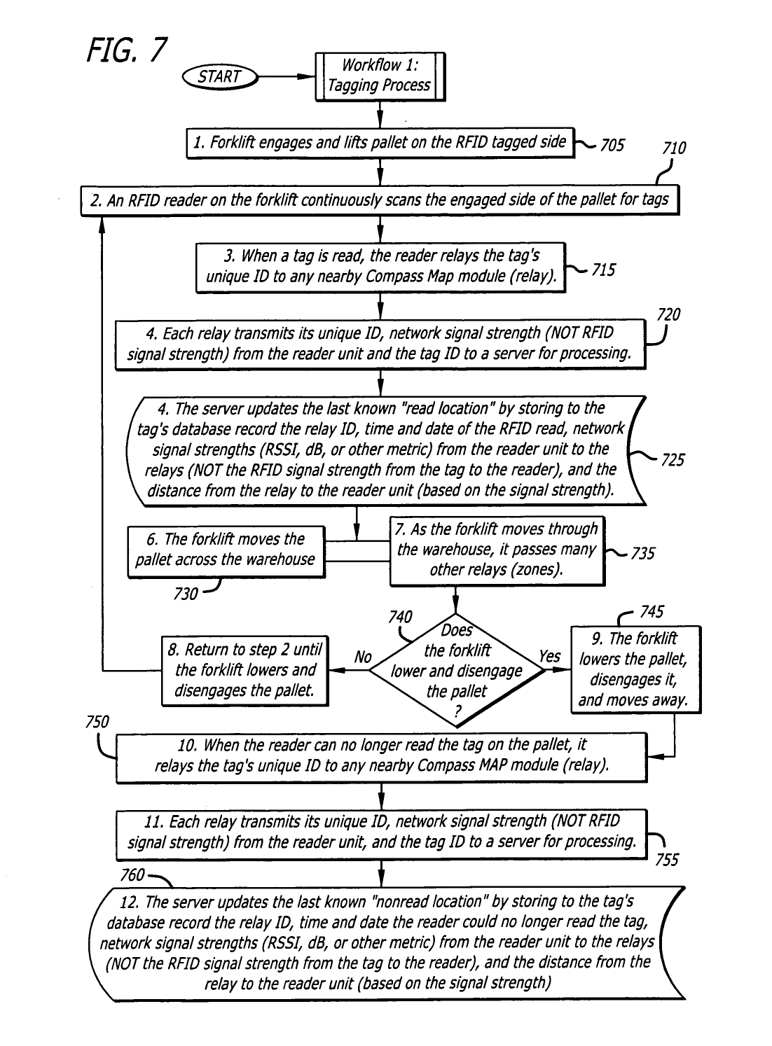

FIG. 5 illustrates one embodiment of a generic workflow for tracking RFID tags 130 affixed to items. FIGS. 6 and 7 jointly illustrate another embodiment of a specific workflow for tracking RFID tags 130 affixed to pallets moved by forklifts.

As shown in the embodiment of FIG. 5, in the first step 505, a fixed or portable RFID reader 120 scans for RFID tags 120. The scanning process may be a singular scan, or a continuous or sporadic scanning process. The scanning process employed may be similar to any of the scanning processes described above with reference to FIGS. 2-4. When an RFID tag 130 is read, the RFID reader 120 relays the RFID tag's unique identifier to the network, for example, through an associated mote 110, as shown in step 510. The mote 110 then transmits the information through the network 100, eventually to the host computer 140 in step 515. In one example, the transmitted information includes the mote's unique network identification, the network signal strength (not the RFID signal strength) from mote 110a with the RFID reader 120, and the RFID tag 130 information. However, the information transmitted may include any information read or calculated by the RFID reader 120 or any of the motes 110.

As shown in step 520, the host computer 140 updates the last known “read location” by storing the information received from the network 100 in an associated database. As described above, the information collected, computed and transmitted may include, for example, any mote's identification, the time and date of the RFID scan, the network signal strengths (RSSI, dB or other metric) from the RFID reader 120 to the motes 110, and the distance from the mote 110 to the RFID reader 120 (calculated using, for example, the network signal strength).

The next step shown in FIG. 5 is step 525, in which the RFID reader 120 determines whether the RFID tag 130 remains in the RFID reader's beam. If so, the process continues in a loop at step 505 described above. If not, the next step, as shown in FIG. 5, is step 530, wherein if the RFID reader 120 can no longer read the RFID tag 130, the RFID reader 120, via an associated mote 110, relays the RFID tag's unique identification number to the network 100. Each mote 110 in the network then transmits its unique network identification, the network signal strength (not the RFID signal strength) from mote 110a with the RFID reader 120, and the RFID tag 130 information, such that the host computer 140 receives this information, via step 535. Finally, in step 540, the host computer 140 updates the last known “non-read location” by storing in the associated database within the RFID tag's record, the mote's identification, the time and date the RFID reader 120 could no longer read the RFID tag 130, the network signal strengths from the mote 110a with RFID reader 120 to the motes 110 and the distance from the motes 110 to the mote 110a with RFID reader 120, based for example on signal strength. Accordingly, the host computer 140 keeps track of the location of each RFID tag 140 within the network 100 via the process shown in FIG. 5.

FIGS. 6 and 7 illustrate another embodiment of tracking RFID tags 130 utilizing the systems and processes described above with respect to FIGS. 1-5. As with all of the examples provided herein, the embodiments described with respect to FIGS. 6 and 7 are provided for purposes of descriptive example and are not provided as limitations on the systems and methods.

As shown in FIG. 6, the example starts with a first step 605 wherein a truck arrives with freight consisting of loaded pallets. Next, in step 610, the pallets are unloaded into a staging area. In step 615, while the pallets are being unloaded, a computer operator operates a host computer 140 including an RFID writer/reader to be used for creating RFID tags 130 for the freight. In one example, the host computer 140 is a desktop computer. In step 620, the computer operator determines whether the inventory type for the new RFID tag 130 to be created is in the database associated with the host computer 140. If the inventory type is not already in the database, the operator adds the inventory type via step 625. Once the operator has confirmed the inventory type is in the system or has added it to the system, the operator selects the inventory type for the RFID tag to be created in step 630. For example, the selection may be made using a dropdown list in the computer interface. Next, in one embodiment, in step 635 the computer operator places, individually or in multiples, RFID tags 130 under the RFID reader/writer to associate them with the selected inventory type. The RFID writer then stores a newly generated unique identification number onto the RFID tag 130 and the RFID tag number is associated with the selected inventory type in the database. In step 645 the operator is notified when the system finishes storing the data. Next, the operator determines whether all of the RFID tags 130 are associated with inventory types in the database in step 650. If not, the process resumes at step 635. If so, the RFID tags 130 are placed on their respective pallets via step 655. To enhance readability, the RFID tags 130 are placed on the side where the forklift engages.

As shown in FIG. 7, after the RFID tags 130 have been attached to their respective pallets, the forklift engages and lifts a first pallet on the RFID tagged side in step 705. Then, in step 710, an RFID reader 120 on the forklift continuously scans the engaged side of the pallet for RFID tags 130. When an RFID tag 130 is read, the RFID reader 120 relays the RFID tag's unique identification to any nearby mote 110 in step 715. Each mote 110 then transmits its unique identification, the network signal strength (RSSI, dB, LQI, TDoA, or other metric) from the mote 110a with RFID reader 120, and the RFID tag 130 information back to the host computer 140 for processing in step 720.

In step 725, the host computer 140 updates the last known “read location” by storing the information received from the network 100 in an associated database. As described above, the information collected, computed and transmitted may include, for example, any mote's identification, the time and date of the RFID scan, the network signal strengths (RSSI, dB, LQI, TDoA, or other metric) from the mote 110a with RFID reader 120 to the motes 110, and the distance from the mote 110 to the mote 110a with RFID reader 120 (calculated using, for example, the link quality index). Then, in step 730, the forklift moves the pallet across the warehouse. As the forklift moves through the warehouse, it passes through various zones defined by RFID readers 120 and associated motes 110 via step 735. In the next step, step 740 a determination is made as to whether the forklift has lowered and disengaged the pallet. If not, the process returns to step 710. If so, the forklift moves away in step 745. When the RFID reader 120 on the forklift can no longer read the RFID tag 130 on the pallet, the RFID reader 120 relays the RFID tag's unique identification number to any nearby mote 110 in step 750. Then, in step 755, each mote 110 relays its unique identification, the network signal strength (not the RFID signal strength) from the mote 110a with RFID reader 120, and the RFID tag 130 information back to the host computer 140 for processing.

Finally, in step 760, the host computer 140 updates the last known “non-read location” by storing in the associated database within the RFID tag's record, the mote's identification, the time and date the RFID reader 120 could no longer read the RFID tag 130, the network signal strengths from the mote 110a with RFID reader 120 to the motes 110 and the distance from the motes 110 to the mote 110a with RFID reader 120, based for example on signal strength. Accordingly, the host computer 140 keeps track of the location of each RFID tag 140 within the network 100 via the process shown in FIGS. 6 and 7.

In a preferred embodiment of the data management and location tracking system described herein, metrics performed at the server 140 only are utilized to determine the location of the objects to be tracked. Preferably, the location tracking system is a real-time location system such that the location of objects may be determined at all times, including during transport or moving of the objects. Additionally, in a preferred embodiment, as explained supra, the network signal strength, such as the received signal strength indicator or RSSI, is utilized to determine the location of objects. In one such embodiment the location of the readers 120 are determined through analysis by the server or host computer 140. Analysis of the location of the readers 120 and motes 110 in the system allows the server 140 to determine the location of the objects to be tracked.

The locations of objects in the system are preferably determined by the server 140 with the use of an algorithm for location tracking by determining the actual location of the readers 120. In one embodiment a weighted or predictive algorithm, such as an exponential moving average (EMA) algorithm is utilized for the location tracking, however, other algorithms or means for determining the item location may be utilized without departing from the scope of the embodiments described and claimed herein. As one of ordinary skill in the art would understand, an exponential moving average, sometimes also called an exponentially weighted moving average (EWMA), applies weighting factors which decrease exponentially. The weighting for each older data point decreases exponentially, giving much more importance to recent observations while still not discarding older observations entirely. Accordingly, in one such embodiment the RSSI is obtained from the network 100, such as from an 802.15.4 wireless mesh network, and an EMA is calculated based on the RSSI from every scan (i.e., read) location. Historical RSSI values are used in connection with the most current RSSI to determine location. In the preferred embodiment triangulation and trigonometry are not utilized because of the increased expense in processing hardware required to perform such operations.

An example of one embodiment is described infra, however, it is understood that numerous variations of the following example may be employed within the scope of the present invention based on the different systems, networks, readers, etc. In this example a mote 110, such as an endpoint mote A 110a, with an integrated reader 120 scans a tag 130. The tag ID and the network ID of mote A 110a, each of which are unique across the network, are sent through the network 100.

Every receiving network mote 110 (which may be a router mote that is not connected to the server, or a coordinator mote that is connected to the server), within range of mote A receives the tag ID and calculates their own network signal strength (RSSI) from mote A. As explained supra, in the preferred embodiment the RSSI is not the RFID signal strength between the tag and the reader. Instead, it is the network signal strength between mote A and each mote that receives mote A's network signal. Because the RSSI between motes 110 is utilized by the server 140 to determine location, endpoint motes 110a need not be fixed in location. Instead, they may move or float within the network as described herein. This provides greater flexibility in the reader position. Next, the RSSI, network mote ID, mote A's ID, and the tag ID are sent through the network, such as a wireless mesh network, to either a coordinator mote connected to the server 140 or directly to the server 140. Moreover, in a preferred embodiment, location data is not sent to the server 140 by the motes 110. Rather, network signal metrics are sent to the server 140 and the network signal data is converted into location data/information at the server 140.

As explained above, coordinator motes 110b are typically connected to a second network, which may be a wired or wireless network, such as for example an 802.11 g wireless network, on which the server 140 resides. In this example, as with all embodiments and examples described herein, there may be several router-type motes 110 that are not connected to the server 140 and are utilized to calculate and transfer data, as well as several coordinator-type motes 110 that are able to send data directly to the server 140.

The server 140 operates a software application that receives the data (tag ID, mote A's ID, the network mote's ID, and RSSI), processes the tag ID, examines the historical RSSI values for the tag/reader/mote combination, determines the location of the reader—for both moving and stationary readers—such as by using the Exponential Moving Average (EMA) on the current RSSI and historical RSSIs, and then stores the current location (along with the IDs). Accordingly, rather than determining the location of the tags based on the RFID signal strength received by the sensors 120, the system preferably determines location based on a network signal metric to determine the location of the readers 120, whether they are stationary or moving. This allows the system to have greater flexibility and be utilized for increased applications.

Additionally, in a preferred embodiment of the system communications are sent from the motes 110, whether they are endpoint motes, router motes or coordinator motes, to the server 140 (i.e., one-way content delivery). In such an embodiment communications are not sent from the server 140 to the motes 110 (i.e., communications are not bi-directional). Further, all of the motes 110 continually and automatically receive data (either tag data or data being transferred from another mote that must be further transmitted to the server) and calculate RSSI for transmission to the server 140. They do not require central site control by the server 140. This system allows for less expensive design and implementation.

In another embodiment separate tags 130 are not utilized. Instead network nodes or motes 110, which exist as part of the network operate as active tags (also referred to as network node beacons 111) and are provided directly on the objects to be tracked. This is an example of another embodiment wherein at least certain motes 110 are not fixed in place, and instead are movable. In a preferred example of this embodiment the network node beacons 111 are wireless mesh network nodes, such as a 2.4 GHz wireless mesh network node. These network node beacons 111 emit a signal which includes network commands, such as their own ID. As in prior embodiment, network motes or routers then receive the signal from the network node beacons and calculate the RSSI, which is transferred to the server 140 as explained herein, and utilized by the server to determine location. Accordingly, in this embodiment a tag reader 120 is not utilized or required. Instead, only network components are used to gather data. The signals received/transmitted are network signals, such as a wireless mesh 802.15.4 network signal. RFID receivers are not required in this embodiment.

Referring now to FIG. 8, an embodiment is disclosed where the location and tag processing server operates on a single server 140. For exemplar purposes, in this embodiment data is gathered at a number of concurrently operating RFID enabled network motes. In one embodiment, each RFID enabled network mote continually issues commands to the embedded RFID reader device to read RFID tag data in the field. Typically, this command is not “event driven” (i.e., there is no independent trigger causing reading to start and stop). Rather, it is executed continuously. When RFID data is encountered, it is preferably buffered into internal embedded memory on the RFID enabled mote. At periodic intervals, this data is sent to the network routing mote over the network, such as a 802.15 RF wireless network. If tag data is not found within the time elapsed during the reader update interval, the tag data is purged from the embedded memory on the RFID enabled network mote, and no data is sent to the server. Preferably, there is only one list of data in the embedded memory on the RFID enabled network mote.

When the network routing mote 110 receives data, it is generally buffered in its internal embedded memory list until a periodic interval elapses, such as a server update interval. In one embodiment, when the interval elapses, all records in the internal embedded memory are preferably sent to the server unit 140. In one embodiment the server 110 unit is connected via a secondary network 142, such as a wired Ethernet connection, 802.11 wireless network, or other acceptable network. The data acquisition software in the server 140 stores the records in the database, such as a SQL server database.

In this embodiment the system also includes an integral data management software/data processing sub-system. In one embodiment as shown in FIG. 8, the data management software includes both a data processing sub-system 146 and a location sub-system 144. The data management software/data processing sub-system preferably retrieves records from the database sub-system and processes the RFID data. In one embodiment, such processing may associate tag IDs with other identifying data stored in the database. The data management software/data processing sub-system may also analyze the information stored in the database records, including the network signal metric, and can execute algorithms determining current location. In a preferred embodiment the location algorithms do not depend on triangulation or GPS data to determine location.

Referring now to FIG. 9, there is shown another embodiment of the location and tag processing system. In this embodiment, the server 140 has a separate location management software/location sub-system 144 from the data processing sub-system 146. Accordingly, in this embodiment data is gathered at a number of concurrently operating RFID enabled network motes. In one embodiment of this system, each RFID enabled network mote continually issues commands to the embedded RFID reader device to read RFID tag data in the field. As in the prior embodiment, this command is typically not “event driven” (i.e., there is no independent trigger causing reading to start and stop). Rather, it is executed continuously. When RFID data is encountered, it is preferably buffered into internal embedded memory on the RFID enabled mote. At periodic intervals, this data is sent to the network routing mote over the network, such as a 802.15 RF wireless network. If tag data is not found within the time elapsed during the reader update interval, the tag data is purged from the embedded memory on the RFID enabled network mote, and no data is sent to the server. Preferably, there is only one list of data in the embedded memory on the RFID enabled network mote.

When the network routing mote 110 receives data, the data is generally buffered in its internal embedded memory list until a periodic interval elapses, such as a server update interval. In one embodiment, when the interval elapses, all records in the internal embedded memory are preferably sent to the server unit 140. In one embodiment the server 140 unit is connected via a secondary network, such as a wired Ethernet connection, 802.11 wireless network, or other acceptable network. The data acquisition software in the server 140 stores the records in the database, such as a SQL server database.

In this embodiment the system also includes a data management software/data processing sub-system and a separate location management software/location sub-system. The data management software/data processing sub-system preferably retrieves records from the database sub-system and processes the RFID data. In one embodiment, such processing may associate tag IDs with other identifying data stored in the database.

In this embodiment, however, the separate location management software/location sub-system will analyze the information stored in the database records, including the network signal metric, and can execute algorithms determining current location. In a preferred embodiment the location algorithms do not depend on triangulation or GPS data to determine location. In this embodiment, the location management software need not be running on the same system as the data management software, although in alternate embodiments they do operate on the same system.

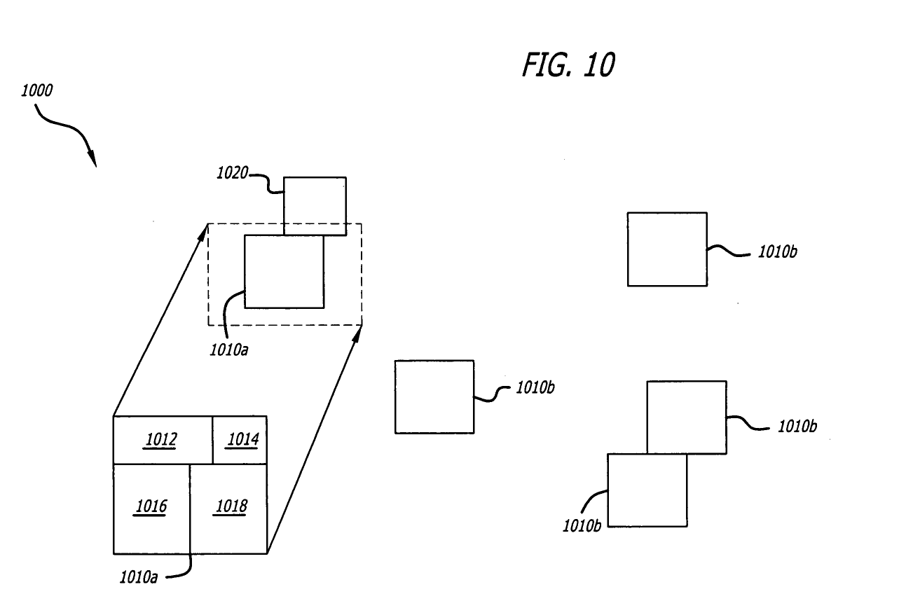

Referring now to FIG. 10, another embodiment is disclosed wherein motes 1010 are connected to a sensor 1020 or a plurality of sensors 1020 for communicating data in a network 1000. Device commands may also be transferred through said network 1000. As shown in the example in FIG. 10, the network 1000 may be a network in which there are at least two pathways of communication to each node, such as a wireless mesh network. However, it is contemplated that any type of network may be used to accomplish the objective of the present invention, including other forms of wired and wireless networks.

In one embodiment a sensor 1020 or a plurality of sensors 1020 are connected to an endpoint mote 1010. The sensor 1020 is capable of retrieving data. In a preferred embodiment the sensor data is atmospheric data such as, but not limited to, temperature, humidity, water pollutant levels, or air pollutant levels. In the preferred embodiment, device commands are not transmitted/received in the network 1000, however, in alternate embodiments, device commands may be transmitted/received in the network 1000 as sensor device commands.

In this embodiment there are also at least two types of motes 1010: endpoint motes 1010a and coordinator motes 1010b. Endpoint motes 1010a are preferably associated with a sensor 1020, for example through an electrical connection, whereas coordinator motes 1010b generally may not be associated with a sensor 1020. Accordingly, endpoint motes 1010a are used to collect and relay data through the network 1000, whereas coordinator motes 1010b simply relay data between motes 1010 (such as a router) or to the server host computer 1400. Additionally, as explained herein, the motes 1010 determine network signal strength.

In this embodiment the network 1000 includes a plurality of motes or nodes 1010, a sensor 1020, and a host computer or server 1040. The host computer or server 1040 includes, inter alia, a controller and software, which may or may not control the communication within and other functions of the network 1000. Each mote 1010 preferably houses memory 1012 associated with a CPU 1014, a wireless mesh network data modulator 1016 and a wireless mesh network receiver/transmitter 1018. The wireless mesh network data modulator 1016 (“WMNDM 1016”) utilizes an algorithm to compile data, such as sensor data, into a packet format for transfer through the wireless network 1000. In a preferred embodiment, however, the mote 1010 does not receive data from the server 1040. Additionally, other than compiling data for ultimate transmission to the server 1040 and determining network signal strength, the motes 1010 do not perform other calculations or computations. Rather, all computations to determine location are performed at the server 1040—the motes 1010 generally do not calculate or know location information. Thus, in a preferred embodiment all location calculation and sensor processing is performed in a single location, at the server 1040. The server 1040 processes sensor information, determines actual location (preferably of an endpoint mote 1010a) which allows for a general determination of the sensor data, and stores the data in a database. Additionally, in a preferred embodiment the motes 1010 do not store location data. All data is stored at the server 1040 in the preferred embodiment. Accordingly, the endpoint and coordinator motes 1010 are much less expensive in the present invention because extraneous memory is not required for the motes 1010.

An example of one embodiment is described infra, however, it is understood that numerous variations of the following example may be employed within the scope of the present invention based on the different systems, networks, sensors, etc. In this example a mote 1010, such as an endpoint mote A 1010a, samples ambient atmosphere with an integrated sensor 1020 or plurality of sensors 1020. The sensor data such as, but not limited to, temperature, humidity, or air pollutant level and the network ID of mote A 1010a, each of which are unique across the network, are sent through the network 1000.

In a preferred embodiment, a plurality of network motes 1010 are used to inventory ambient atmospheric data such as, but not limited to, temperature, humidity, carbon dioxide levels, or other pollutant levels. The receiving network motes 1010 (which may be router motes that are not connected to the server and/or coordinator motes that are connected to the server), within range of mote A receives the atmospheric sensor data and also calculates their own network signal strength (RSSI) from mote A. As explained supra, in the preferred embodiment the RSSI is the network signal strength between mote A and each mote that receives mote A's network signal. Because the RSSI between motes 1010 is utilized by the server 1040 to determine location, endpoint motes 1010a need not be fixed in location. Instead, they may move or float within the network as described herein. This provides greater flexibility in the sensor position. Next, the RSSI, network mote ID, mote A's ID, and the sensor data are sent through the network, such as a wireless mesh network, to either a coordinator mote connected to the server 1040 or directly to the server 1040. Moreover, in a preferred embodiment, location data is not sent to the server 1040 by the motes 1010. Rather, network signal metrics are sent to the server 1040 and the network signal data is converted into location data/information at the server 1040.

As explained above, coordinator motes 1010b are typically connected to a second network, which may be a wired or wireless network, such as for example an 802.11 g wireless network, on which the server 1040 resides. In this example, as with all embodiments and examples described herein, there may be several router-type motes 1010 that are not connected to the server 1040 and are utilized to calculate and transfer data, as well as several coordinator-type motes 1010 that are able to send data directly to the server 1040.

The server 1040 operates a software application that receives the data (for example sensor data, mote A's ID, the network mote's ID, and RSSI), processes the sensor data, examines the historical RSSI values for the sensor/mote combination, determines the location of the mote—for both moving and stationary motes—such as by using the Exponential Moving Average (EMA) on the current RSSI and historical RSSIs, and then stores the current location (along with the IDs). The system, as described supra, preferably determines location based on a network signal metric to determine the location of the motes 1010, whether they are stationary or moving. This allows the system to have greater flexibility and be utilized for increased applications.

Additionally, in a preferred embodiment of the system communications are sent from the motes 1010, whether they are endpoint motes, router motes or coordinator motes, to the server 1040 (i.e., one-way content delivery). In such an embodiment communications are not sent from the server 1040 to the motes 1010 (i.e., communications are not bi-directional). Further, all of the motes 1010 continually and automatically receive data (either sensor data or data being transferred from another mote that must be further transmitted to the server) and calculate RSSI for transmission to the server 1040. They do not require central site control by the server 1040. This system allows for less expensive design and implementation.

As shown by the above descriptions, aspects of the systems are controlled by one or more controllers. Typically, the one or more controllers are implemented by one or more programmable data processing devices. The hardware elements operating systems and programming languages of such devices are conventional in nature, and it is presumed that those skilled in the art are adequately familiar therewith. Accordingly, any device that may be used to perform the functions described herein with respect to the controller may be substituted for the controllers described in the examples above. For example, in some instances the functions of the controller may be embodied in programmable instructions, for example, on a CD-ROM, a flash drive or any other memory.

For example, the controller may be a microprocessor in a portable arrangement, such as, for example, a cellular phone, a personal digital assistant, an audio/video playing device, etc. These systems including microprocessors are referred to generically herein as computer systems. In another example, the controller may be a PC based implementation of a central control processing system. The PC based system contains a central processing unit (CPU), memories and an interconnect bus. The CPU may contain a single microprocessor (e.g. a Pentium microprocessor), or it may contain a plurality of microprocessors for configuring the CPU as a multi-processor system. The other components of the computer system described above include memories, including a main memory, such as a dynamic random access memory (DRAM) and cache, as well as a read only memory, such as a PROM, an EPROM, a FLASH-EPROM, or the like. The system also includes mass storage devices such as various disk drives, tape drives, etc. In operation, the main memory stores at least portions of instructions for execution by the CPU and data for processing in accord with the executed instructions.

The mass storage may include one or more magnetic disk or tape drives or optical disk drives, for storing data and instructions for use by CPU. For example, at least one mass storage system in the form of a disk drive or tape drive, stores the operating system and various application software as well as data. The mass storage within the computer system may also include one or more drives for various portable media, such as a floppy disk, any optical storage device such as Compact Disc Read Only Memory (CD-ROM), Digital Versatile Disc Recordable media (DVD-R and/or DVD-RW), or BluRay recordable media (BD-R and/or BD-Re), or an integrated circuit non-volatile memory adapter (i.e. PC-MCIA adapter) to input and output data and code to and from the computer system.

The computer system also includes one or more input/output interfaces for communications, shown by way of example as an interface for data communications with one or more processing systems. Although not shown, one or more such interfaces may enable communications via a network, e.g., to enable sending and receiving instructions electronically. The physical communication links may be optical, wired, or wireless.

The computer system may further include appropriate input/output ports for interconnection with a display and a keyboard serving as the respective user interface for the controller. For example, the computer system may include a graphics subsystem to drive the output display. The output display, for example, may include a cathode ray tube (CRT) display, or a liquid crystal display (LCD) or other type of display device. Although not shown, a PC type system implementation typically would include a port for connection to a printer. The input control devices for such an implementation of the computer system would include the keyboard for inputting alphanumeric and other key information. The input control devices for the computer system may further include a cursor control device (not shown), such as a mouse, a touchpad, a trackball, stylus, or cursor direction keys. The links of the peripherals to the computer system may be wired connections or use wireless communications.

The computer system runs a variety of applications programs and stores data, enabling one or more interactions via the user interface provided, and/or over a network to implement the desired processing.

The components contained in the systems are those typically found in general purpose computer systems. Although illustrated as a PC type device, those skilled in the art will recognize that the class of applicable computer systems also encompasses systems used as servers, workstations, network terminals, and the like. In fact, these components are intended to represent a broad category of such computer components that are well known in the art.

A software or program product may take the form of code or executable instructions for causing a computer or other programmable equipment to perform the relevant data processing steps, where the code or instructions are carried by or otherwise embodied in a medium readable by a computer or other machine. Instructions or code for implementing such operations may be in the form of computer instruction in any form (e.g., source code, object code, interpreted code, etc.) stored in or carried by any readable medium.

Terms relating to computer or machine “readable medium” that may embody programming refer to any medium that participates in providing code or instructions to a processor for execution. Such a medium may take many forms, including but not limited to non-volatile media, volatile media, and transmission media. Non-volatile media include, for example, optical or magnetic disks, such as any of the storage devices in the computer system. Volatile media include dynamic memory, such as main memory. Transmission media include coaxial cables; copper wire and fiber optics including the wires that comprise a bus within a computer system. Transmission media can also take the form of electric or electromagnetic signals, or acoustic or light waves such as those generated during radio frequency or infrared data communications. In addition to storing programming in one or more data processing elements, various forms of computer readable media may be involved in carrying one or more sequences of one or more instructions to a processor for execution, for example, to install appropriate software in a system intended to serve as the controller 14.

Several alternative embodiments and examples have been described and illustrated herein. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. Additionally, the terms “first,” “second,” “third,” and “fourth” as used herein are intended for illustrative purposes only and do not limit the embodiments in any way. Further, the term “plurality” as used herein indicates any number greater than one, either disjunctively or conjunctively, as necessary, up to an infinite number.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind without significantly departing from the spirit of the invention and the scope of protection is only limited by the scope of the accompanying Claims.

What is claimed is:

1. A wireless locating network, comprising:
a tag containing data;
a reader to read the data from the tag;
at least one network mote, the mote having a wireless mesh network receiver/transmitter, a wireless mesh network data modulator, a CPU, and memory; and,
a host computer, wherein the host computer is adapted to track the location of the tag within the wireless network via communication between said tag, said reader, said communication mote and said host computer.

2. The wireless locating network of claim 1, wherein the tag is a RFID tag that contains RFID tag data.

3. The wireless locating network of claim 1, wherein a first network mote operates as a router and only communicates with readers and other network motes, and wherein a second network mote communicates with the host computer.

4. The wireless locating network of claim 1, wherein the host computer processes tag data, determines an actual location of the reader receiving the tag data, and stores the tag data in a database.

5. The wireless locating network of claim 1, wherein the tag is adapted to be connected to an object to be tracked.

6. The wireless locating network of claim 1, wherein the mote does not store location data.

7. The wireless location network of claim 1, wherein all location determinations are performed by the host computer.

8. The wireless locating network of claim 1, wherein the host computer performs calculations based on a predictive algorithm for tracking purposes.

9. The wireless locating network of claim 1, wherein at least one of the motes has a reader.

10. The wireless locating network of claim 1, wherein at least one of the motes does not have a reader.

11. The wireless locating network of claim 1, wherein one or more motes determine the network signal strength.

12. The wireless locating network of claim 11, wherein the host computer performs calculations involving the network signal strength received from the motes and determines the location of the reader.

13. The wireless locating network of claim 12, wherein historical network signal strength values are used in connection with the most current network signal strength to the determine location of the reader.

14. The wireless locating network of claim 1, wherein the host computer resides on a network separate from the wireless mesh network.

15. The wireless locating network of claim 1, wherein a portion of the reader is moveable to increase the scan area of the reader.

16. A wireless location system, comprising:
a plurality of network tags, each tag having independent tag data and each tag emitting a signal containing the tag data;
a plurality of network readers to continuously receive data from tags within a certain range of the reader, the readers further transmitting the received tag data;
a plurality of communication motes to receive the tag data from the readers, the communication motes calculating the network signal strength of the signal between the reader and the mote; and,
a server to receive the tag data and network signal strength data from the communication mote, wherein the server also performs calculations on the data and determines the location of the reader that received the tag data based in part on the received network signal strength data.

17. The wireless location system of claim 16, wherein at least one of the readers is movable within the network.

18. A wireless location system, comprising:
a plurality of wireless mesh node beacons adapted to be fixed to movable objects;
a wireless mesh communication mote having a receiver/transmitter, data modulator, processor and associated memory, the mote receiving a signal from the beacon;
a host computer, wherein said host computer identifies an object following communication from the communication mote, and wherein the host computer tracks the location of each beacon.

19. The wireless location system of claim 18, wherein the host computer has a database that stores data associated with the objects, and an integral location and data processing sub-system that analyzes information stored in the database and executes algorithms to determine the current location, in real time, of the network beacon.

20. A wireless location system, comprising:
a plurality of node beacons adapted to be fixed to movable objects, the node beacons sending a signal contain data related to the object to which it is fixed;
a communication mote having a receiver/transmitter, wherein the mote receives the signal from the beacon and buffers the data in its internal memory, and wherein the mote also performs a network signal calculation; and,
a host server resident on a secondary network, wherein the host server receives data from the communication mote related to the network signal calculation and the signal the mote received from the beacon, identifies the object having the node beacon, processes the data and tracks the location of each beacon, and stores the data in a database resident in the host server.

21. A wireless locating network, comprising:
a sensor;
at least one network mote, the mote having a wireless mesh network receiver/transmitter, a wireless mesh network data modulator, a CPU, and memory; and,
a host computer, wherein the host computer is adapted to track the location of the mote within the wireless network via communication between said sensor, said communication mote and said host computer.

22. The wireless locating network of claim 21, wherein a first network mote operates as a router and only communicates with sensors and other network motes, and wherein a second network mote communicates with the host computer.

23. The wireless locating network of claim 21, wherein the host computer processes sensor data, determines an actual location of the mote receiving the sensor data based on network signal strength data, and stores the sensor data in a database.

24. The wireless locating network of claim 21, wherein the sensor obtains atmospheric data and transmits the atmospheric data to the network mote.

25. The wireless location network of claim 21, wherein all location determinations are performed by the host computer.
